(19) United States
(12) Patent Application Publication
(10) Pub. No.: US 2025/0202923 A1
(43) Pub. Date: Jun. 19, 2025

(54) CONTACT RATES IN MALWARE SIMULATION FOR RESPONSIVE MEASURE DEPLOYMENT

(71) Applicant: BRITISH TELECOMMUNICATIONS PUBLIC LIMITED COMPANY, London (GB)

(72) Inventors: Alfie BEARD, London (GB); Tom BOWMAN, London (GB); Alexander HEALING, London (GB)

(21) Appl. No.: 18/844,729

(22) PCT Filed: Feb. 13, 2023
(86) PCT No.: PCT/EP2023/053489

§ 371 Date: Sep. 6, 2024

(30) Foreign Application Priority Data
Mar. 10, 2022 (GB) 2203361.7

(51) Int. Cl. H04L 9/40; H04L 43/50

(52) U.S. Cl. CPC H04L 63/1433; H04L 43/50; H04L 63/145

(57) ABSTRACT

A computer-implemented method of simulating the propagation of malware in a network is provided. The method comprises accessing a model of the network, where the model comprises a plurality of computer nodes and where each computer node of the plurality of computer nodes is connected to at least one edge of a plurality of edges. Each edge of the plurality of edges connects a pair of computer nodes of the plurality of computer nodes. The method further comprises initiating an outbreak of the malware in the model at a predetermined source computer node of the plurality of computer nodes, and propagating the malware through the model of the network from the source computer node. The propagation is determined based on a rate of transmission, where the rate of transmission is based upon a contact rate for each edge of the plurality of edges, and the contact rate for each edge of the plurality of edges is based upon the network traffic passing between the computer nodes connected by that edge over a predetermined time period.

### TECHNICAL FIELD

Embodiments described herein relate generally to simulations of malware propagation through computer networks.

### BACKGROUND

Conventional malware protection mechanisms are reactive to the detection of malware in a network or the widespread distribution of anti-malware measures. Such approaches are known as “diagnosis and treatment”. Mitigation measures such as anti-malware or malware-specific protective measures may not be known for some time after an infection has been studied for its effects. Accordingly, it is beneficial to provide improvements in the simulation of the propagation of such infections through computer networks, thereby allowing for faster and more appropriate selection of malware protection mechanisms.

### SUMMARY OF INVENTION

The present application relates to the field of a simulation of a network and, in particular, a network subject to a threat or attack such as malware or the like. The simulation is arranged to simulate the propagation of the threat through the network as each entity in the network (i.e. each device or machine) goes through a process of being susceptible to infection, then infected, then detected (i.e. infection is detected), then ultimately removed (e.g. the infection is either remediated, mitigated or the entity is disconnected/removed from the network).

In accordance with a first aspect of the invention, there is provided a computer-implemented method of simulating the propagation of malware in a network, the method comprising: accessing a model of the network, the model comprising a plurality of computer nodes, each computer node of the plurality of computer nodes being connected to at least one edge of a plurality of edges, wherein each edge of the plurality of edges connects a pair of computer nodes of the plurality of computer nodes; initiating an outbreak of the malware in the model at a predetermined source computer node of the plurality of computer nodes; and propagating the malware through the model of the network from the source computer node, the propagation being determined based on a rate of transmission, wherein the rate of transmission is based upon a contact rate for each edge of the plurality of edges; wherein the contact rate for each edge of the plurality of edges is based upon the network traffic passing between the computer nodes connected by that edge over a predetermined time period.

The present invention therefore provides a method of simulating the propagation of malware through a computer network, where the simulation provided employs contact rates that are specific to each connection between computers on the network. Such individualised contact rates may be based upon real network traffic data for the computer network in question. As such, the simulation is more realistic, allowing for a better understanding of the behaviour of the malware in the specific computer network in question. As a result, a malware protection measure may be selected that is more effective and therefore more able to contain, counteract, or pre-emptively prevent a real malware infection in that computer network.

Any of the following may be applied to the above first aspect of the invention.

The contact rate for each edge of the plurality of edges may be based at least upon the amount of data passing along the corresponding edge over the predetermined time period.

Alternatively or additionally, the contact rate for each edge of the plurality of edges may be based at least upon the number of packets of data passing along the corresponding edge over the predetermined time period.

The contact rate for each edge of the plurality of edges may be based at least upon one or more ports of the computer nodes, the one or more ports being used for the network traffic passing between the computer nodes connected by that edge over a predetermined time period.

The contact rate for each edge of the plurality of edges may be based at least upon the how recently data has passed along the corresponding edge over the predetermined time period.

The rate of transmission for each edge of the plurality of edges may be at least partially determined according to a decaying exponential function; wherein the decaying exponential function may be defined by the contact rate being based upon the how recently data has passed along the corresponding edge over the predetermined time period.

In accordance with a second aspect of the invention, there is provided a computer implemented malware protection method to protect at least a subset of a set of computer systems from a malware, the method comprising: simulating a propagation of the malware through the set of computer systems using a model of the set of computer systems, wherein the simulating comprises any of the methods of the first aspect of the invention discussed above; and identifying one or more malware protection measures to be deployed to one or more of the set of computer systems based on the simulating.

In accordance with a third aspect of the invention, there is provided a computer implemented malware protection method to protect at least a subset of a set of computer systems from a malware, the method comprising: accessing a model of the set of computer systems, the model identifying computer systems in the set and interactions therebetween based on previous communication occurring between the computer systems, each interaction being identified for an interacting pair of computer systems, wherein each computer system is identified by the model as having an indication of a state of malware infection as at least one of susceptible to infection by the malware and infected by the malware; simulating a propagation of the malware through the set of computer systems using the model, wherein the simulating comprises any of the methods of the first aspect of the invention discussed above; and responsive to the simulating step, identifying one or more malware protection measures to be deployed to one or more of the set of computer systems.

The computer implemented malware protection method of the second or third aspect of the invention may additionally include deploying the one or more malware protection measures to the one or more computer systems.

In accordance with a fourth aspect of the invention, there is provided a system comprising: one or more processors; a non-transitory memory; and one or more programs, wherein the one or more programs are stored in the non-transitory memory and configured to be executed by the one or more processors, the one or more programs including instructions for performing any of the methods of the first, second, or third aspects of the invention discussed above.

In accordance with a fifth aspect of the invention, there is provided a non-transitory computer readable storage medium storing one or more programs, the one or more programs comprising instructions, which, when executed by an electronic device with one or more processors, cause the electronic device to perform any of the methods of the first, second, or third aspects of the invention discussed above.

In the following, embodiments will be described with reference to the drawings in which:

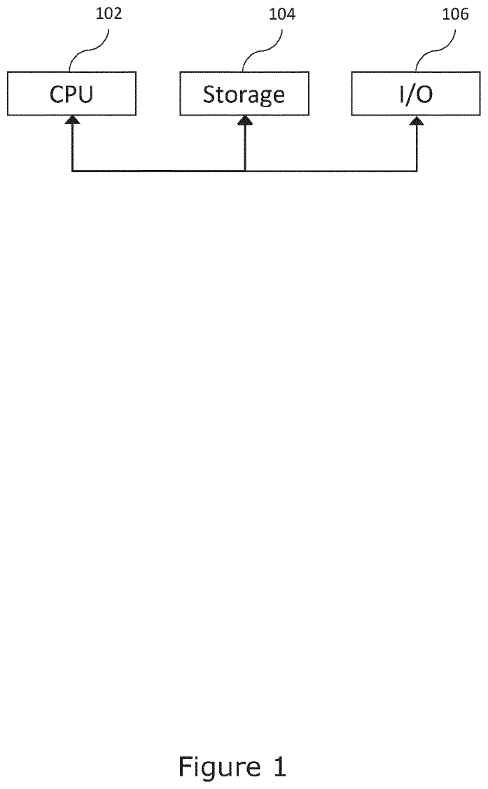

FIG. 1 shows a block diagram of a computer system suitable for the operation of the method according to some embodiments.

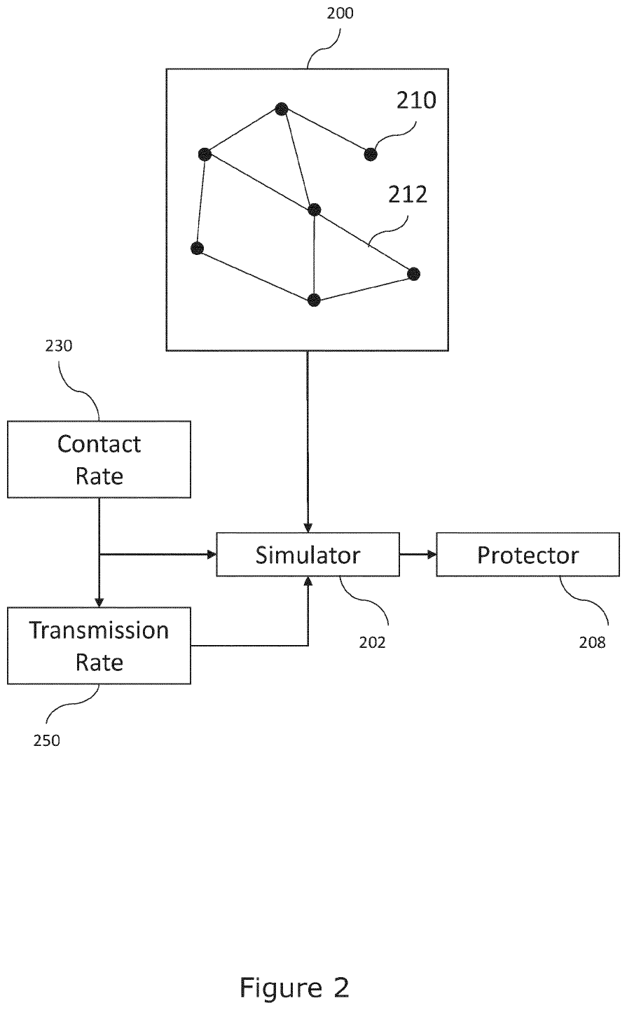

FIG. 2 shows a component diagram of an arrangement for malware protection for at least a subset of a set of computer systems according to some embodiments.

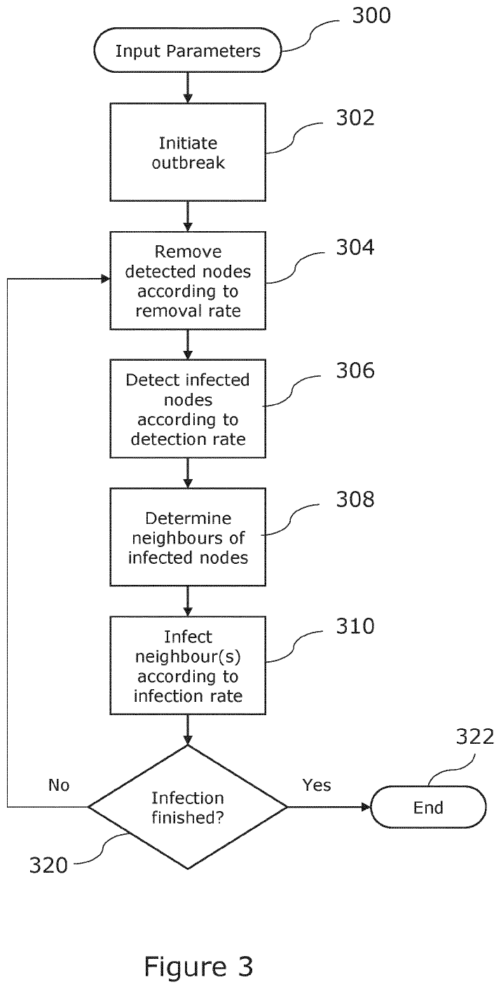

FIG. 3 shows a flowchart of a simulation of malware propagation through a network according to some embodiments.

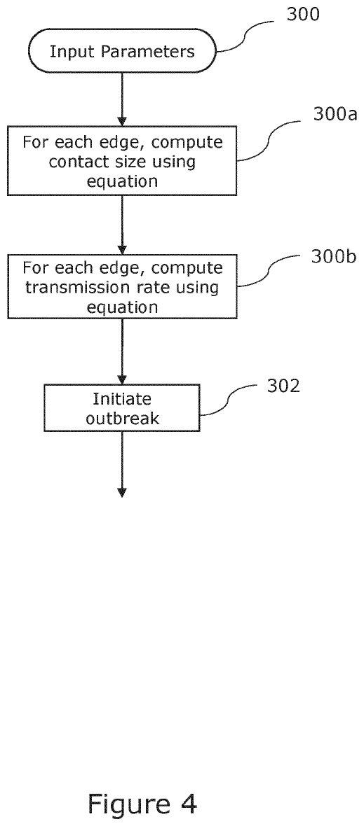

FIG. 4 shows a flowchart of a simulation of malware propagation through a network employing individual contact rates according to some embodiments.

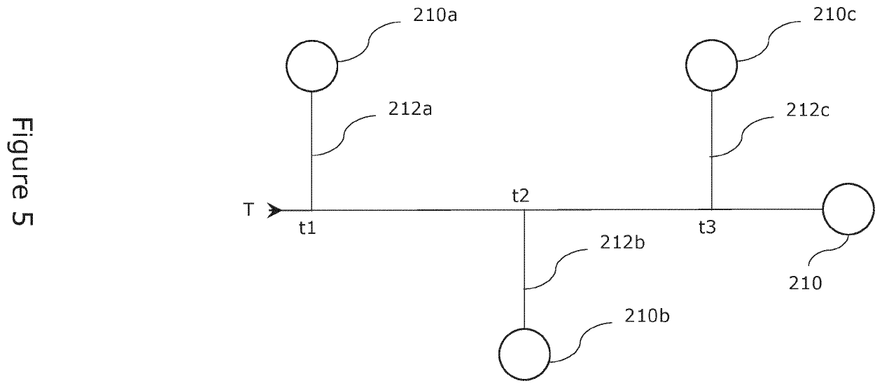

FIG. 5 shows a timeline of network traffic activity for a single node according to some embodiments.

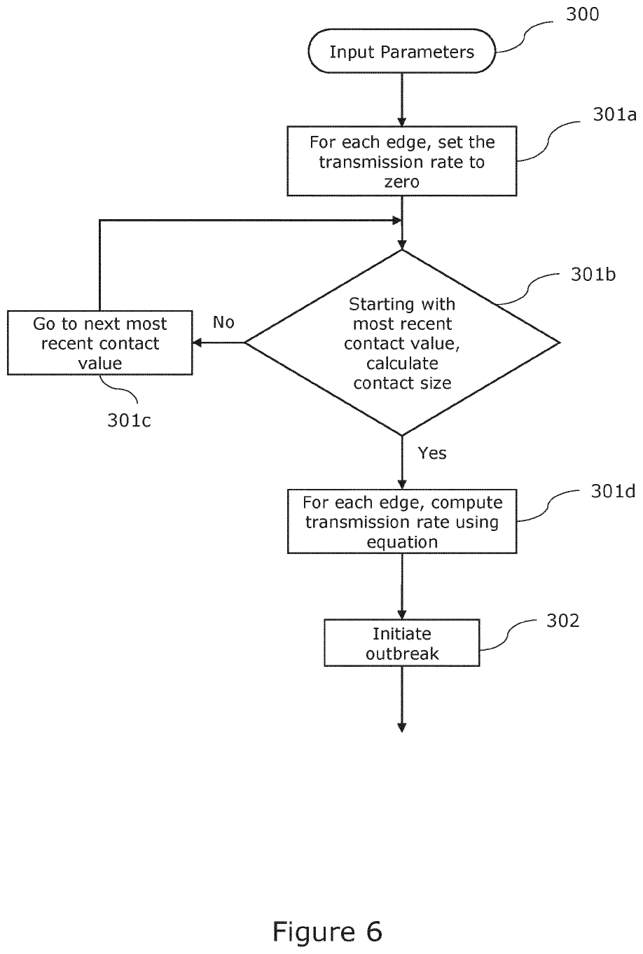

FIG. 6 shows a flowchart of a simulation of malware propagation through a network in which contact rates are calculated according to the recentness of a contact according to some embodiments.

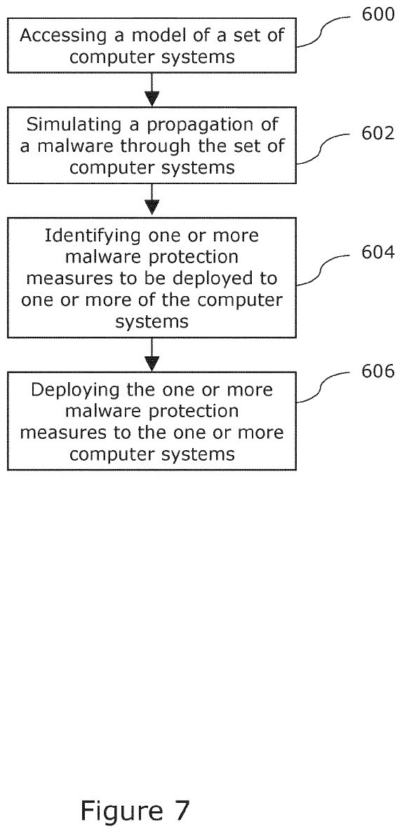

FIG. 7 shows a flowchart of a malware protection method employing the simulation according to some embodiments.

### DETAILED DESCRIPTION

The simulation of the present application models the propagation of a threat/infection/malware across the network based on modelled network communications and interactions between entities. Conventionally, such simulations employ a variety of parameters in such a model including: infection rates; detection rates; removal rates and the like. In conventional simulations, these rates are defined for the entire simulation, or at least a network or sub-network.

FIG. 1 is a block diagram of a computer system suitable for the operation of the present method according to some embodiments. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Malicious software, also known as computer contaminants or malware, is software that is intended to do direct or indirect harm in relation to one or more computer systems. Such harm can manifest as the disruption or prevention of the operation of all or part of a computer system, accessing private, sensitive, secure and/or secret data, software and/or resources of computing facilities, or the performance of illicit, illegal or fraudulent acts. Malware includes, inter alia, computer viruses, worms, botnets, trojans, spyware, adware, rootkits, keyloggers, dialers, malicious browser extensions or plugins and rogue security software.

Malware proliferation can occur in a number of ways. Malware can be communicated as part of an email such as an attachment or embedding. Alternatively, malware can be disguised as, or embedded, appended or otherwise communicated with or within, genuine software. Some malware is able to propagate via storage devices such as removable, mobile or portable storage including memory cards, disk drives, memory sticks and the like, or via shared or network attached storage. Malware can also be communicated over computer network connections such as the internet via websites or other network facilities or resources. Malware can propagate by exploiting vulnerabilities in computer systems such as vulnerabilities in software or hardware components including software applications, browsers, operating systems, device drivers or networking, interface or storage hardware.

A vulnerability is a weakness in a computer system, such as a computer, operating system, network of connected computers or one or more software components such as applications. Such weaknesses can manifest as defects, errors or bugs in software code that present an exploitable security weakness. An example of such a weakness is a buffer-overrun vulnerability, in which, in one form, an interface designed to store data in an area of memory allows a caller to supply more data than will fit in the area of memory. The extra data can overwrite executable code stored in the memory and thus such a weakness can permit the storage of malicious executable code within an executable area of memory. An example of such malicious executable code is known as ‘shellcode’ which can be used to exploit a vulnerability by, for example, the execution, installation and/or reconfiguration of resources in a computer system. Such weaknesses, once exploited, can bootstrap a process of greater exploitation of a target system, and propagation of the malware to other computer systems. The effects of malware on the operation and/or security of a computer system lead to a need to identify malware in a computer system in order to implement protective and/or remedial measures.

While malware detection is often directed to computer systems themselves or the networks over which they communicate, embodiments of the present invention recognise that interactions between computer systems transcend the physical interconnections therebetween.

In particular, embodiments of the present invention are directed to addressing interactions between electronic devices or computer systems that arise from communication between pairs of electronic devices or computer systems in a network. Such interactions can include, for example, interactions between users of each of a pair of electronic device or computer systems using, inter alia, social media, messaging, electronic mail or file sharing facilities. Thus, embodiments of the present invention employ a model or simulation of a set of electronic devices or computer systems in which interacting pairs of computer systems are identified, such interactions being based on previous communication occurring between the electronic device or computer systems in the pair.

Notably, such a model (or simulation) may disregard intermediates in an interaction—such as physical resources or other computer systems involved in a communication. For example, an interaction arising from a social media communication between two users using each of a pair of computer systems will involve potentially multiple physical or logical networks, intermediate servers, service provider hosts, intermediate communication appliances and the like.

As a result, a model (or simulation) of the physical communication becomes burdened by the intermediate features of a typical inter-computer communication. In contrast, embodiments of the present invention address the endpoints of an interaction such as the computer systems through which users communicate. A similar analysis can be conducted for interactions involving email, electronic messaging, file sharing and the like.

Ideally, the behaviour and characteristics of an infection in the simulation of the infected network accurately reflects the behaviour and characteristics of an infection in a real network. Embodiments of the present invention relate to improvements in such simulations, providing a more accurate simulation of the propagation of malware through a network (i.e. compared with the propagation of malware through a real network). This allows for a more effective determination of suitable mitigation measures that can be employed to mitigate the spread of the malware, or infection, throughout the network. The deployment of malware protection measures is targeted to provide an effective and/or efficient inhibition of the propagation of the infection on the network.

The nature and type of malware protection measures themselves are understood by those skilled in the art and can include, inter alia: anti-malware facilities; malware filters; malware detectors; a block, preclusion or cessation of interaction and/or communication, such as between computer systems; and/or a reconfiguration of one or more computer systems or communications facilities therebetween.

Embodiments of the present invention identify computer systems or interacting pairs of computer systems for the deployment of malware protection measures based on a simulation of a propagation of malware through the model of a set of computer systems. Such a simulation employs simulation parameters including: a rate of interaction (or a contact rate) between each interacting pair of computer systems (i.e. a number of interactions per time period); a rate of transmission of the malware between interacting computer systems per interaction; a rate of detection of malware in the network; and a rate of removal of computer systems from the network to slow or stop the rate of infection. Some or all of these parameters may be derived statistically according to a statistical distribution. In some embodiments, some or all of these parameters may be determined based on historical interaction information over a historical time period. In some embodiments, some or all of these parameters are determined based on one or more machine learning processes based on historical interaction information.

Preferably, mitigation measures are intended to directly affect the transmission rate, detection rate, and/or removal rate for a malware, or an infection, propagating through a network. For example, implementing an adjustment or supplement to security facilities such as antimalware, proxies, firewalls and the like within the network such as by modifying policies for such facilities can directly affect one or more of these rates.

Mitigative measures can further include protective or interruptive measures including one or more of, inter alia: deployment of malware remediation facilities such as anti-malware; the isolation of a subset of the network by interrupting communications along one or more selected edges; the disconnection of one or more devices from the network; the instigation of protective measures in respect of data stored at devices in advance of their predicted infection such as backup, storage, offlining or disconnection of sensitive data stores; the generation of new networks of devices such as to exclude devices predicted to be infected; affecting a transmission rate within a network or between pairs of devices in the network such as by throttling or otherwise affecting a rate or frequency of communication between devices, or to limit/constrain a “size” of communication (e.g. payload size) or otherwise constrain communication (e.g. imposing new limits) [all of these are particularly beneficial]; and the propagation of alerts and/or information to devices on the network. Such mitigative measure can be determined and configured cognisant of the time required to effect such mitigation and the forecast state of the network and malware infection over such a time period.

FIG. 2 is a component diagram of an arrangement for malware protection for at least a subset of a set of computer systems according to an embodiment of the present invention. A model 200 is provided as one or more data structures representing a set of computer systems and interactions therebetween. Preferably, the model is provided as a graph or similar data structure including nodes or vertices 210, each corresponding to a computer system, and edges 212 each connecting a pair of nodes 210 and representing interaction between electronic devices or computer systems corresponding to each node in the pair. Thus, an edge 212 represents interaction between a pair of electronic devices or computer systems. Each node 210 can have associated information for a corresponding node (i.e. electronic device or computer system) including, for example, inter alia: an identifier of the computer system; an identification of an organisational affiliation of the computer system; an identifier of a subnet to which the computer system is connected; and other information as will be apparent to those skilled in the art.

Preferably, an edge 212 constitutes an indication that at least one interaction has taken place over at least a predetermined historic time period between computer systems in a pair. Preferably, the existence of an edge 212 is not determinative, indicative or reflective in of itself of a degree, frequency, or propensity of interaction between computer systems in a pair. Rather, the edge 212 identifies that interaction between nodes can or has taken place. In some embodiments, edges 212 can have associated, for example, inter alia: an edge identifier; an identification of a pair of nodes (and/or the corresponding electronic devices or computer systems) that the edge interconnects; and/or interaction frequency information between a pair of computer systems.

It will be appreciated by those skilled in the art that, while the model 200 is illustrated as a literal graph in the arrangement of FIG. 2, alternative data structures and logical representations of vertices and edges can be used, such as representations employing, for example, inter alia, vectors, arrays of vectors, matrices, compressed data structures and the like.

The arrangement of FIG. 2 includes a simulator 202 as a hardware, software, firmware or combination component arranged to perform a simulation of a propagation of a malware in the set of computer systems represented by the model 200.

The simulator 202 is operable on the basis of simulation parameters including: an contact rate as a number of interactions between pairs of interacting computer systems in a time period; and a transmission rate 250 as a rate of transmission of a malware between computer systems in a pair of systems per interaction. The transmission rate 250 is a probability of transmission of a malware from one node to another node during an interaction between the nodes. The transmission rate 250 may incorporate aspects of a malware infection process.

For example, in the case of malware transmitted as a web-link between two computer systems by email, the transmission rate can reflect all of: a probability that an email is communicated between the two computer systems; a probability that the email includes the malicious web-link; and a probability that a recipient accesses the malicious web-link resulting in malware infection.

The simulator 202 can operate on the basis of configurable characteristics such as simulation assumptions. For example, the simulator 202 may operate on the basis that any computer system as represented by a node in the model 200 can only transmit the malware to first-degree neighbours according to the model 200.

Further, the simulator 202 preferably operates on the basis that each computer system has a state of infection at a point in time. States of infection at a point in time can include, for example: a state of susceptibility in which a computer system is susceptible to infection, such as a computer system that is not and has not been so far infected and is not specifically protected from infection by a particular malware; a state of infected in which a computer system is subject to infection by the malware at the point in time; and a state of removed or remediated in which a computer system is remediated of a past infection or protected from prospective infection by the malware.

It will be appreciated by those skilled in the art that sub-states of these states can also be employed, such as, inter alia: an infected state that is not infectious (i.e. transmission of malware cannot be effected by a computer system in such a state); an infected state that is infectious; an infected state that is detected; and an infected state that is not detected (such as might be determined by the simulator 202).

Therefore, in use, the simulator 202 is operable for a time period to model the propagation of a malware infection. In some embodiments, one or more predetermined source computer systems represented in the model 200 are selected as originating computer systems for the malware infection such that propagation is simulated from such originating computer systems. Preferably, the simulator 202 is executed for each of a plurality of time periods so as to model the propagation of the malware in the set of computer systems over time. Additionally or alternatively, the simulator 202 can be performed a plurality of times for each of a plurality of predetermined source computer systems selected as originating computer systems for the malware infection.

FIG. 3 is a flowchart illustrating a simulation of propagation of a malware according to some embodiments. In this example, the simulation is built on a network graph model (e.g. such as that illustrated in FIG. 2).

At step 300, several parameters are defined for the simulation and input into the simulator, including a removal rate, a detection rate and an infection rate. Each of these parameters takes a value between 0 and 1. In some embodiments, one or malware protection measures may be deployed. The malware protection measures may be any one of the malware protection measures described herein.

In the present example, each of the nodes has four Boolean states: susceptible, infected, detected, and removed. Initially, every node is set to susceptible, uninfected, undetected and not removed. At step 302, an outbreak is initiated by setting the state of one or more nodes to infected. These nodes may be referred to as “outbreak nodes”.

At step 304, detected nodes are randomly removed from the network according to the removal rate. That is to say, the infected nodes that have been detected are isolated from the rest of the network (i.e. by severing the connection to neighbouring nodes). The state of these nodes is set to “removed”.

At step 306, a number of the infected nodes are detected according to the detection rate. The state of these nodes is set to “detected”.

At step 308, the neighbours of the infected nodes are determined. The susceptible neighbours are then infected according to the infection rate at step 310. The state of these nodes is set to “infected”.

At step 320, it is determined whether the infection is finished, i.e. whether the malware is able to spread any further, or if the maximum number of steps for the simulation has been reached. For example, if the infected nodes are all removed, then these nodes cannot infect any other nodes and the malware cannot spread any further. If the malware cannot spread any further, the simulation ends at step 322, and optionally statistics for the simulation are calculated. Otherwise, if the malware can still spread further, steps 304-310 are repeated.

Steps 304 to 308 are discussed above in a particular sequence. However, it will be appreciated that this sequence is not intended to be limiting, and steps 304 to 308 may instead be carried out in any appropriate sequence or order.

As is further shown in FIG. 2, responsive to the simulation by the simulator 202, and, in particular, responsive to the model of propagation of a malware determined by the simulator 202, a protector component 208 may be implemented. Here, the protector 208 may be operable to deploy malware protection measures intended to inhibit a propagation of the malware through the set of computer systems. The protector component 208 may be a hardware, software, firmware or combination component arranged to access output from the simulator 202 such as one or more models, data structure representations, images, animations, visually renderable indications or other suitable representations of states of nodes corresponding to simulated states of computer systems in the set of computer systems. For example, a representation of states of computer systems may be provided based on the model 200 so as to indicate, for each computer system by way of a node in the model 200, a state of the computer system (such as susceptible, infected, removed) over each of a plurality of time periods for which the simulator 202 was executed.

The protector 208 may identify one or more computer systems or interacting pairs of computer systems (such as are represented by edges 212 in the model 200) for the deployment of malware protection measures. Such identified systems or pairs of systems can be selected based on, for example, inter alia: a computer system or interacting pair of systems through which malware propagates in the simulation to a subset of other computer systems in the set of computer systems; identifying a subset of computer systems having a relatively greater, or greatest, proportion of computer systems infected by the malware according to the simulation, so as to identify one or more computer systems or pairs of systems as a gateway, link or bridge to such identified subset; a number of computer systems to which the malware is propagated via a computer system or pair of systems; and other criteria as will be apparent to those skilled in the art. For example, “choke-points” in the model 200 can be identified by the protector 208 based on the simulator 202 output as nodes or pairs of nodes representing computer systems or interacting pairs of systems constituting pathways for propagation of the malware to subsets of nodes in the model 200. The malware protection measures deployed by the protector 208 can include those previously described, and in this way at least a subset of the set of computer systems can be protected from the malware by the targeted deployment of malware protection measures.

In view of the above, the simulator 202 can be used to simulate the propagation of malware through a computer network (or computer system) in a realistic manner, such that the protector 208 may use the simulation to improve the selection of one or more appropriate malware protection measures for implementing in the computer network. Such appropriately selected one or more malware protection measures may then be deployed in a computer network (or computer system), either in response to a real malware infection, or as a pre-emptive measure to prevent or reduce the likelihood of an infection propagating. Consequently, the more realistic the simulation of malware propagation in the modelled computer network is, the better the protector 208 is able to select an appropriate and effective malware protection measure to contain, counteract, or pre-emptively prevent a real malware infection in the computer network.

When setting the parameters for the simulation, the specific contact rate 230 (and, by extension, the transmission rate 250) for each edge 212 may be determined individually, based on network traffic data along that edge 212.

Specifically, the details of the connections between devices from the network traffic data may be used to generate contact rates 230 for each edge 212 in the model 200. These contact rates 230 can be used to calculate the overall transmission rate 250 for each edge 212, thereby providing individualised transmission rates 250 for every edge 212 in the model 200 of the network based on specific network traffic.

In conventional simulations of malware propagations, the infection rate along each connection (i.e. each edge 212) in the network may be fixed for every connection. In the present application, the network traffic data is used to capture information on the “size” of the contact between each device on the network.

As a result, this provides more realism to the model 200, so that the malware can spread through the network in the simulation in a manner that is more representative of in the real world. In addition, by determining the contact rate 230 for each edge 212 individually, users of the simulation are able to modify the model 200 for different malware variants (for example, for smaller/greater payload sizes).

To generate a contact rate 230 between a given pair of nodes 210 connected by an edge 212 in the model 200 of the network, a contact size 240 is determined for a given period of time. The contact size 240 is a measure of the amount, degree, or timing of contact (i.e. network traffic) between the nodes 210 connected by that particular edge 212 over that chosen period of time.

In some embodiments, the contact size 240 for each edge 212 in the model 200 of the network may be generated based on the frequency of contact (i.e. the number of contacts) between the two nodes 210 connected by each edge 212 over a given time period. That is to say, if two nodes 210 contact each other along a particular edge 212 more frequently then the contact size 240, and by extension the contact rate 230, is larger.

In some embodiments, the contact size 240 may be determined based on the number of number of groups of packets of data, or “flows”, that pass along an edge 212 between two nodes 210 within the chosen time period.

For example, the contact size 240 for an edge 212 may be calculated using the following equation:

$$contact\_size \_for \_edge = ⌊ \frac{ flows}{single\_contact \_size} ⌋ \qquad ( 1 )$$

For instance, if two nodes 210 exchange 8 packets of data (i.e. 8 flows) along their connecting edge 212 (i.e. #flows in Equation 1) within a chosen time period of 10 minutes, and if the size of a “contact” is set to be equal to 3 packets of data or 3 flows (i.e. single_contact_size in Equation 1), then the contact size 240 for that edge 212 is equal to 2. As a result, the contact rate 230 for that edge 212 is 2 per 10 minutes.

In some embodiments, the contact size 240 may be determined based on the total amount of data that passes along an edge 212 between two nodes 210 within a given period of time.

For example, the contact size 240 for an edge 212 may be calculated using the following equation:

$$contact\_size \_for \_edge = ⌊ \frac{ bytes}{single\_contact \_size} ⌋ \qquad ( 2 )$$

For instance, if two nodes 210 exchange 500 bytes of data along their connecting edge 212 (i.e. #bytes in Equation 2) within a chosen time period of 5 minutes, and if the size of a “contact” is set to be equal to 60 bytes of data (i.e. single_contact_size in Equation 2), then the contact size 240 for that edge 212 is equal to 8. As a result, the contact rate 230 for that edge 212 is 8 per 5 minutes.

In some further embodiments, the contact size 240 may be determined based on the particular port or ports used to communicate between the two nodes 210. That is to say, the contact size 240 may be determined based on the total amount of data (or, alternatively, the number of flows) that passes along an edge 212 between a particular port or set of ports of the two nodes 210 within a given period of time. This allows the simulation of the model 200 to consider malware propagation along only those particular data paths for each edge 212 that are considered to be most relevant, ignoring data paths for each edge 212 that are considered irrelevant. For instance, the simulation is able to consider only infections that pass between particular ports on each node 210 associated with certain types of data.

It will be appreciated that, in any of the above examples, the size of a “contact” may be set to any appropriate value (i.e. any number of flows, bytes, or ports) based on the specific scenario being simulated (i.e. based on the specific network in question, the type of data being exchanged, or the specific type malware propagation being simulated). Likewise, any appropriate period of time may be chosen to calculate the contact rate 230.

It will also be appreciated that the contact size 240 for a given edge 212 may also be determined based on a combination of the above factors. That is to say, the contact size 240 over a given period of time for a given edge 212 may be determined based on a combination of any one or more of the number of flows of data passing between the associated nodes 210, the number of bytes passing between the associated nodes 210, or the specific ports of the nodes 210 being used.

The network traffic used to determine the contact rate 230 for each edge 212 in the network may be based on real network traffic, such as in a case where the model 200 is used to simulate an infection propagating through a real network.

After a contact rate 230 for a given edge 212 is determined, the transmission rate 250 can then be used to calculate the probabilistic rate at which malware would propagate along that particular edge 212 (i.e. from one associated infected node to a neighbouring associated uninfected node).

In some embodiments, the transmission rate 250 for a particular edge 212 may be calculated using the following equation:

$$transmission rate for edge = 1 - {( 1 - p )}^{contact \_ size \_ for \_ edge} \qquad ( 3 )$$

For example, if the transmission rate 250 for one contact (i.e. p in Equation 3) is set to be equal to 0.02, and the contact size for that edge 212 (i.e. the number of contacts, or contact_size_for_edge in Equation 3) is equal to 6, then the transmission rate 250 for that particular edge 212 is 0.114.

The transmission rate 250 for one contact (i.e. p in Equation 3) may be set based upon specific parameters associated with the particular simulation in question. For instance, the transmission rate 250 for one contact may be based upon the specific network in question, or the specific type of malware that is being simulated.

Equation 3 above may be derived from known laws of probability. Nonetheless, it will be understood that a skilled reader may choose to employ a different suitable equation for calculating the transmission rate 250 for a given edge 212.

A “contact” may also be measured based upon the existence of a particular property. For example, if two devices share a network file share or both have the same port open, then this property may correspond to one contact, whereas any other instances without the network file share or ports open do not have contact.

FIG. 4 shows a flowchart according to some embodiments. Here, at step 300, the network graph model is inputted to the simulator, along with the chosen equation for calculating the contact size for each edge 212 and the equation chosen for the transmission rate 250 for each edge 212. In addition, a removal rate, a detection rate and an infection rate are input into the simulator. Each of these “rate” parameters takes a value between 0 and 1.

At step 300a, the contact size 240 for each edge is calculated using an appropriate equation based on the chosen definition of a “contact”.

For instance, if a “contact” is determined based on the number of flows passing along an edge 212 over a given time period, then Equation 1 may be used. Alternatively, if a “contact” is determined based on the amount of data (i.e. the number of bytes) passing along an edge 212 over a given time period, then Equation 2 may be used. As a further alterative, an appropriate equation combining the aspects of Equations 1 and 2 may be used if a “contact” is defined both in terms of flows and the amount of data passing along an edge over the given time period.

Then, at step 300b, the transmission rate 250 for each edge 212 is calculated. The transmission rate 250 for each edge 212 may be calculated based on Equation 3, or may be calculated based on an equivalent appropriate chosen equation.

Once the transmission rate 250 for each edge 212 has been calculated, the outbreak can be initiated, as shown in step 302. From this point, the simulation proceeds in the same manner as discussed above with respect to FIG. 3 (i.e. steps 304 to 320 of that figure).

In some embodiments, the contact rate 230 for each edge 212 in the model 200 of the network may be generated based at least in part on the recentness of contact between the two nodes 210 connected by the edge 212 in question. That is to say, if two nodes 210 have contacted each other along a particular edge 212 recently then the contact rate 230, and by extension the transmission rate 250, is larger.

Specifically, in some embodiments, devices that have contacted each other more recently along a given edge 212 may have a greater contact rate 230 (provided that contact meets the chosen minimum requirements for a “contact”).

For example, if a device or node 210 contacts a first device or node 210a frequently along a first edge 212a, but has contacted a second device or node 210b, different to the first device or node 210a, more recently along a second edge 212b, the contact rate 230 along the second edge 212b may be higher than the contact rate 230 along the first edge 212a. Consequently, the transmission rate 250 along the second edge 212b may be higher than the transmission rate 250 along the first edge 212a.

FIG. 5 shows an example representation of this approach, in which the three most recent “contacts” for a given device or subject node 210 are shown on a timeline T. Here, at time t1, a first node 210a contacts the subject node 210 along a first edge 212a. Then, at time t2, a second node 210b contacts the subject node 210 along a second edge 212b. Finally, at time t3, a third node 210c contacts the subject node 210 along a third edge 212c.

As a result, the contact rate 230 along the third edge 212c is greater than the contact rate 230 along the second edge 212b, and the contact rate 230 along the second edge 212b is greater than the contact rate 230 along the first edge 212a.

Here, the definition of a “contact” may be selected based upon any of the measures previously discussed (i.e. by number of packets of data or flows, by the amount of data, or by the ports used to exchange that data).

Consequently, the transmission rate 250 for the first edge 212a may, for example, be 0.85. By comparison, the transmission rate 250 for the second edge 212b may, for example, be 0.90. Then, the transmission rate 250 for the third edge 212c may, for example, be 0.95. That is to say, the third edge 212c, having contacted the subject node 210 most recently, has the highest transmission rate 250.

The calculation of the transmission rate 250 for a given edge 212, based on the recentness of the last contact along that edge 212 (i.e. which is at least a part of the contact rate 230 in this embodiment), may be based on a decaying exponential equation. For example, the transmission rate 250 for a given edge 212 may be calculated using the following decaying exponential equation:

$$transmission rate for edge = {e}^{- λ t} \qquad ( 4 )$$

For example, if the decay constant (i.e. λ in Equation 4) is set to be equal to 0.1, and the time since the last contact (i.e. t in Equation 4) along the chosen edge 212 is equal to 12 minutes, then the transmission rate 250 for that particular edge 212 is 0.3.

The decay constant (i.e. λ in Equation 4) may be set based upon specific parameters associated with the particular simulation in question. For instance, the decay constant (i.e. λ in Equation 4) may be based upon the specific network in question, or the specific type of malware that is being simulated.

As a result, such more recently contacted devices or nodes may be “top of the list”, such that malware may be more likely to spread to them (for example, in the case of a more recent email appearing at the top of the inbox/sent list).

Equation 4 above provides an exponential decay in the likelihood of transmission along a given edge 212 against the time since the last contact for that edge 212. Nonetheless, it will be understood that a skilled reader may choose to employ a different suitable equation for calculating the transmission rate 250 for a given edge 212 based on the recentness of the last contact along that edge 212.

FIG. 6 shows a flowchart that implements a combination of frequency-based rates and recentness rates for all the edges 212 from a sample network traffic dataset.

As in previous embodiments, at step 300 the network graph model is inputted to the simulator, along with the chosen equation for calculating the contact size for each edge 212 and the equation chosen for the transmission rate 250 for each edge 212. In addition, the removal rate, detection rate, and infection rate are input into the simulator. At step 301a, the transmission rate 250 for each edge 212 is set to zero.

Then, at step 301b, contact rates 230 are calculated for each edge 212 in reverse chronological order using the sample network traffic dataset. For example, a sample network traffic dataset, for nodes 210a, 210b, 210c, and 210d, may be as follows:
0: {‘Source’: ‘210a’, ‘Destination’: ‘210b’, ‘Bytes’: 600, ‘Time’: 11:00}
1: {‘Source’: ‘210b’, ‘Destination’: ‘210c’, ‘Bytes’: 800, ‘Time’: 10:59}
2: {‘Source’: ‘210c’, ‘Destination’: ‘210d’, ‘Bytes’: 200, ‘Time’: 10:57}
3: {‘Source’: ‘210a’, ‘Destination’: ‘210b’, ‘Bytes’: 600, ‘Time’: 10:55}

Starting with the most recent contact (i.e. entry ‘0’, having a time of 11:00), the contact size for each contact is determined. Taking a chosen size of a “contact” in this example to be equal to 300 bytes of data (i.e. single_contact_size in Equation 2), then the contact size 240 for the edge 212 connecting nodes 210a and 210b is equal to 2. This is then repeated via step 301c for the next most recent entry (i.e. entry ‘1’, having a time of 10:59), resulting in a contact size 240 for the edge 212 connecting nodes 210b and 210c that is also equal to 2 (i.e. 800/300 using Equation 2). For the next most recent entry (i.e. entry ‘2’, having a time of 10:57), the number of bytes is only 200, which is less than the chosen contact size of 300 bytes, so the contact size 240 for the edge 212 connecting nodes 210c and 210d is 0.

This process is therefore repeated, in reverse chronological order, for each contact in the sample network traffic dataset.

In the case of entry ‘3’, the contact is a duplicate entry (i.e. this entry concerns a contact along the edge 212 connecting nodes 210a and 210b, which is the same as the more recent entry ‘0’). Since this is a duplicate entry, it may be ignored, as the contact size 240 (and, by extension, the contact rate 230) has already been calculated for that edge 212 based on a more recent contact.

In some embodiments, entry ‘3’ may alternatively not be ignored, and the calculated contact rate 230 may instead be updated to be dampened based on the frequency of the contacts along that edge 212 (i.e. depending on the time passed between each contact on that edge 212).

For example, entry ‘3’ concerns a contact of 600 bytes so that, based on the size of a “contact” being chosen to be 300 bytes, the contact size 240 for that edge 212 based on that contact is 2. However, since 5 minutes have passed since the last contact (i.e. entry ‘0’), an exponential decay can be applied to dampen the contact rate 230 for that edge 212. For example, employing an exponential decay equation (i.e. of the same type as that shown in Equation (4) for transmission rate 250), using a decay constant λ that is equal to 0.1 and a time value t of 5 minutes between contacts, produces a damping constant of 0.61. As a result, this can be applied to the above contact size 240 of 2 to arrive at a contact size 240 of 1.22 for entry ‘3’. This contact size 240 for entry ‘3’ can then be added to the existing contact size 240 for entry ‘0’ (which is for the same edge 212) to get a contact size 240 of 3.22 for the edge 212 connecting nodes 210a and 210b.

Once the contact size 240, and by extension the contact rate 230, for each edge 212 in the network has been calculated, the transmission rate 250 for each edge 212 can be calculated in step 301d (for example, by using Equation 3 discussed above, or by any other appropriate method).

Once the transmission rate 250 for each edge 212 has been calculated, the outbreak can be initiated, as shown in step 302. From this point, the simulation proceeds in the same manner as discussed above with respect to FIG. 3 (i.e. steps 304 to 320 of that figure).

Therefore, the approach of the embodiment shown in FIG. 6 allows for the malware simulation to be more dynamic. For example, if there is a time associated with the simulation, the transmission rates 250 can be calculated as discussed above, using both time-based contact data (i.e. the recentness of a contact) and quantity-based contact data (i.e. the amount of data associated with a contact).

In addition, in some embodiments, as the simulation progresses, newly acquired network traffic data may be used to recalculate the transmission rate 250 for each edge 212 to account for more recent contacts (i.e. if the number or size of contacts for a given edge 212 increases or decreases with time).

By using the time and recentness of a contact, it is possible to simulate malware that targets devices that have been in recent communication.

The advantage of the contact rate 230 being affected by the recentness of the contact is that this enables a user to infer the likelihood of transmission between two devices or nodes at an individual level, thereby providing more realism to the simulations compared with employing a fixed infection rate for each edge 212.

In some embodiments, the contact rate 230 (and, by extension, the transmission rate 250) for a given edge 212 may be calculated based on a combination of both the contact size 240 (i.e. based on one or more of the number of bytes, the number of packets of data/flows, or the ports used for data exchange) and the recentness of a given contact for that edge 212.

The skilled reader will recognise that, when defining the contact rate 230 based on a selection of different types of contact size 240 and/or the recentness of a given contact, multiple different mathematical definitions for the contact rate 230 may be employed. That is to say, individual weightings for each aspect may be employed in the definition of the contact rate 230. For example, the number of bytes of data may have a greater weighting than the number of packets of data when calculating the overall contact rate 230, or the recentness of a contact may have a greater weight than the size of that contact (measured in terms of one or both of the number of bytes or number of packets/flows that pass along that edge in the given time period).

As an alternative, the transmission rate 250 for a given edge 212 may be calculated using a combination of a transmission rate 250 based on the contact size 240, and a transmission rate 250 based on the recentness of a contact. That is to say, the transmission rate 250 may be calculated using a combination of Equation 3 and Equation 4 (or whatever suitable equations are chosen in each case, including a suitable chosen weighting for each element).

The generation of a contact rate 230 for each edge 212 in the network model 200, and by extension the calculation of the transmission rate 250 for each edge 212 in the network model 200, allows for the simulation to simulate the propagation of malware through that network more realistically. This therefore leads to improved strategies for countering the propagation of malware through such networks, such as where a strategy may be developed and tailored for a specific network in response infection by specific malware.

FIG. 7 is a flowchart of a malware protection method according to some embodiments. The malware protection method aims to protect at least a subset of a set of computer systems from a malware.

At step 600, a model of a set of computer systems is accessed. The model may be a graph, e.g. as shown in FIG. 2. The model identifies computer systems in the set and interactions therebetween based on previous communication occurring between the computer systems. Each interaction is identified for an interacting pair of computer systems, and each computer system is identified by the model as having an indication of a state of malware infection as one of susceptible to infection by the malware and infected by the malware.

At step 602, propagation of the malware through the set of computer systems is simulated using the model (e.g. by the simulator 202). The simulation may be performed using any of the methods described herein, for example the method described above in relation to any of FIGS. 3 to 6.

At step 604, one or more malware protection measures that are to be deployed to one or more computer systems are identified. The malware protection measures are identified based on the results of the simulation performed in step 602.

At step 606, the malware protection measures identified in step 604 are deployed to the one or more computer systems (e.g. by the protector 208).

The malware protection measure selected may then be better informed by the implementation of a more realistic simulation in which the transmission rate 250 between each node 210 is set based on a specific contact rate 230 for each edge 212. That is to say, employing a simulation according to embodiments described herein will lead to different choices of what the optimal mitigation is.

For example, in a conventional simulator, the best mitigation may be selected to isolate the detected node, since each neighbour can be infected equally (i.e. the contact rate 230 along each edge 212 is constant).

By comparison, when employing the simulator in the embodiments described herein, it is possible to discount edges to nodes with very low transmission rates (i.e. with low or zero contact rates). Hence, a more optimal mitigation measure may be selected. For instance, it may be optimal to patch only a single node 210 connected to an infected node 210, where the edge 212 connecting the infected node 210 to the single node 210 has a higher transmission rate 250, and ignore other connected nodes 210 that have a low transmission rate 250 along the edge 212 connecting those other nodes 210 to the infected node 210. In conventional simulations that do not employ varying contact rates, the optimal protection measure may instead be to patch all connected nodes to the infected node, which may require more time and place a heavier burden on the computer network as a whole.

Non-optimal mitigation(s) may fail to resolve the threat and can cause unnecessary consequences, hence using varying contact rates to ensure more realistic simulations provides for improved mitigation measures.

The embodiments described herein employ contact rates that vary for each edge in the computer network, allowing for a more realistic malware spread in the simulation. Here, the malware may have a lower likelihood of infecting some devices or computers on the computer network, due to lower contact rates (and therefore transmission rates) that exist along the associated connecting edges, which is not possible in simulations where each edge (or “link”) in the computer network is considered equal. This provides a more detailed understanding of how a chosen malware will spread, which ultimately allows for more informed decisions to be taken with regard to which mitigation measures to select.

Any of the above discussed methods may be performed using a computer system or similar computational resource, or system comprising one or more processors and a non-transitory memory storing one or more programs configured to execute the method. Likewise, a non-transitory computer readable storage medium may store one or more programs that comprise instructions that, when executed, carry out the methods described herein.

Whilst certain embodiments have been described, these embodiments have been presented by way of example only, and are not intended to limit the scope of the application. Indeed, the novel devices, and methods described herein may be embodied in a variety of other forms; furthermore, various omissions, substitutions and changes in the form of the devices, methods and products described herein may be made without departing from the scope of the present application. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage. The accompanying claims and their equivalents are intended to cover such forms or modifications as would fall within the scope of the application.

1. A computer-implemented method of simulating the propagation of malware in a network, the method comprising:
accessing a model of the network, the model comprising a plurality of computer nodes, each computer node of the plurality of computer nodes being connected to at least one edge of a plurality of edges, wherein each edge of the plurality of edges connects a pair of computer nodes of the plurality of computer nodes;
initiating an outbreak of the malware in the model at a predetermined source computer node of the plurality of computer nodes; and
propagating the malware through the model of the network from the source computer node, the propagation being determined based on a rate of transmission, wherein the rate of transmission is based upon a contact rate for each edge of the plurality of edges;
wherein the contact rate for each edge of the plurality of edges is based upon the network traffic passing between the computer nodes connected by that edge over a predetermined time period.

2. A method according to claim 1, wherein the contact rate for each edge of the plurality of edges is based at least upon the amount of data passing along the corresponding edge over the predetermined time period.

3. A method according to claim 1, wherein the contact rate for each edge of the plurality of edges is based at least upon the number of packets of data passing along the corresponding edge over the predetermined time period.

4. A method according to claim 1, wherein the contact rate for each edge of the plurality of edges is based at least upon one or more ports of the computer nodes, the one or more ports being used for the network traffic passing between the computer nodes connected by that edge over a predetermined time period.

5. A method according to claim 1, wherein the contact rate for each edge of the plurality of edges is based at least upon the how recently data has passed along the corresponding edge over the predetermined time period.

6. A method according to claim 5, wherein the rate of transmission for each edge of the plurality of edges is at least partially determined according to a decaying exponential function;
wherein the decaying exponential function is defined by the contact rate being based upon the how recently data has passed along the corresponding edge over the predetermined time period.

7. A computer implemented malware protection method to protect at least a subset of a set of computer systems from a malware, the method comprising:
simulating a propagation of the malware through the set of computer systems using a model of the set of computer systems, wherein the simulating comprises the method of claim 1; and
identifying one or more malware protection measures to be deployed to one or more of the set of computer systems based on the simulating.

8. The method of claim 7, comprising:
deploying the one or more malware protection measures to the one or more computer systems.

9. A system comprising:
one or more processors;
a non-transitory memory; and
one or more programs, wherein the one or more programs are stored in the non-transitory memory and configured to be executed by the one or more processors, the one or more programs including instructions for performing any of the methods of claim 1.

10. A non-transitory computer readable storage medium storing one or more programs, the one or more programs comprising instructions, which, when executed by an electronic device with one or more processors, cause the electronic device to perform any of the methods of claim 1.
